(19) United States
(12) Patent Application Publication
(10) Pub. No.: US 2014/0130967 A1
(43) Pub. Date: May 15, 2014

(54) SOFT ADHESIVE FABRIC TO COVER TAGS AND SEAMS IN CLOTHING

(71) Applicant: Kelly Ann Oberholtzer, Marietta, GA (US)

(72) Inventor: Kelly Ann Oberholtzer, Marietta, GA (US)

(21) Appl. No.: 13/674,051

(22) Filed: Nov. 11, 2012

(51) Int. Cl. B32B 37/12

(52) U.S. Cl. CPC B32B 37/12
USPC 156/247; 156/60

(57) ABSTRACT

A fabric has an adhesive on one side that can be used to cover tags and seams in articles of clothing. Typically, people remove tags from clothing to prevent irritation from the tags. However, this can cause holes in the fabric and also can result in the user losing size and care information for the garment. The adhesive fabric can be used to cover the tags and seams that may be uncomfortable, providing a soft fabric material attaches to the article of clothing so as not to rub against and irritate the wearer. The adhesive fabric does not alter the condition of the apparel for further use, sale or consignment.

### BACKGROUND OF THE INVENTION

The present invention relates to clothing accessories and, more particularly, to a soft adhesive fabric to cover tags and seams in clothing and methods for making tags and seams in clothing more comfortable for the clothing wearer.

Tags and seams in clothing can be very itchy and uncomfortable. However, if they are torn or cut out, holes can be left in the clothing. Children are even more sensitive to itchy tags and seams. When tags are cut or torn out, it can be hard to know what size the clothing is for hand me downs or consignment and there is a risk of tearing holes in the fabric.

As can be seen, there is a need for a device and method for making tags and seams comfortable for the wearer without requiring tearing or cutting out the tags.

### SUMMARY OF THE INVENTION

In one aspect of the present invention, a method for covering a portion of an inside of an article of clothing comprises placing a tag cover over the portion of the inside of the article of clothing, wherein the tag cover has a soft fabric layer and an adhesive layer disposed on one side of the soft fabric layer, wherein the soft fabric layer is disposed outward toward a wearer of the article of clothing.

In another aspect of the present invention, a method for reducing discomfort from clothing tags or seams comprises obtaining a desired length of a tag cover, the tag cover including a soft fabric layer with an adhesive layer disposed on one side of the soft fabric layer; and disposing the tag cover over the clothing tags or seams, wherein the soft fabric layer is disposed outward toward the wearer.

These and other features, aspects and advantages of the present invention will become better understood with reference to the following drawings, description and claims.

### BRIEF DESCRIPTION OF THE DRAWINGS

FIG. 1 is a front view of an article of clothing having an adhesive fabric installed to cover the clothing tag, according to an exemplary embodiment of the present invention;

FIG. 2 is a cross-sectional view taken along line 2-2 of FIG. 1; and

FIG. 3 is a perspective view of a dispenser for providing a user with a length of adhesive fabric for covering seams and tags in clothing according to an exemplary method of the present invention.

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Broadly, an embodiment of the present invention provides a fabric having an adhesive on one side thereof that can be used to cover tags and seams in articles of clothing. Typically, people remove tags from clothing to prevent irritation from the tags. However, this can cause holes in the fabric and also can result in the user losing size and care information for the garment. The adhesive fabric can be used to cover the tags and seams that may be uncomfortable, providing a soft fabric material attaches to the article of clothing so as not to rub against and irritate the wearer. The adhesive fabric does not alter the condition of the apparel for further use, sale or consignment.

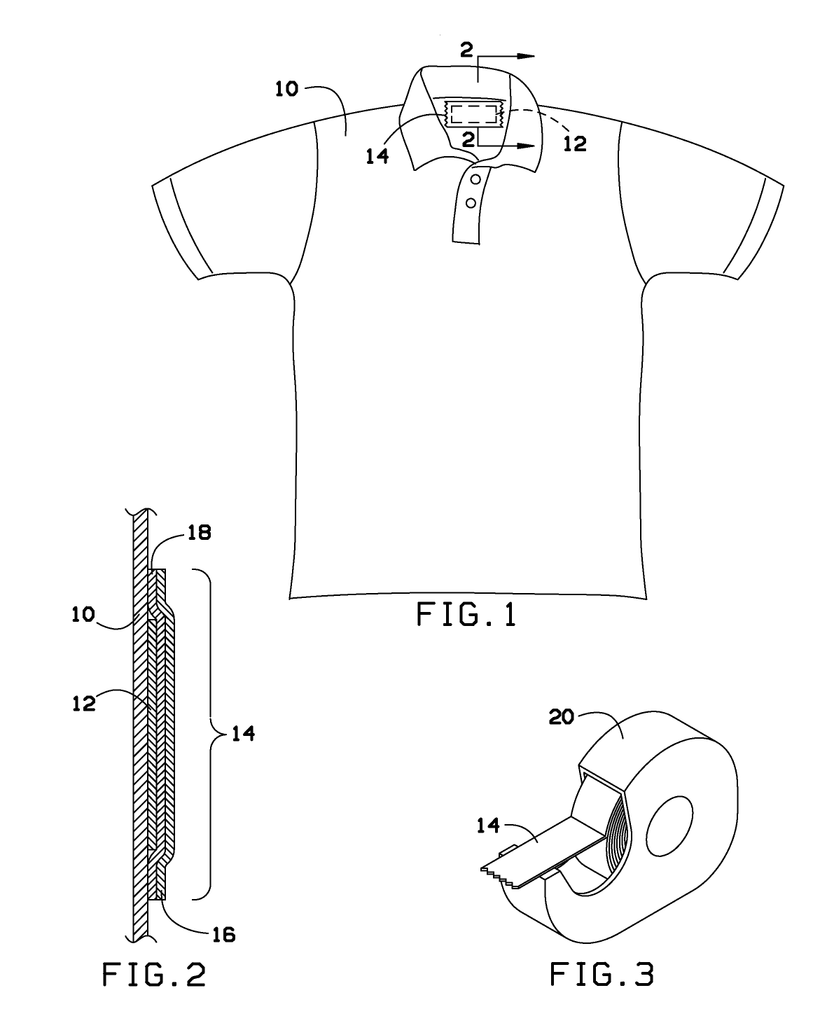

Referring to FIGS. 1 through 3, an article of clothing 10 can include a clothing tag 12 disposed on an inside surface of the article of clothing 10. The clothing tag 12 is often stitched or otherwise attached to the article of clothing 10 along one edge thereof, allowing the clothing tag 12 to be turned upside down to view garment information, for example. These clothing tags 12, however, can cause irritation and discomfort to clothing wearers, as the tags are often made of a material that is different from the article of clothing 10 itself, and can rub and poke at the wearer during use. To solve this problem, people often tear or cut out these tags, often to the detriment of the garment.

A tag cover 14 can be used to cover the clothing tag 12, preventing the clothing tag 12 from coming into contact with the user's skin. The tag cover 14 can include a soft fabric outer layer 16 with an adhesive layer 18 disposed on one side of the soft fabric outer layer 16. The tag cover 14 can be placed over the entirety of the clothing tag 12, covering the clothing tag 12, and providing the user with a soft fabric outer layer 16 contacting their skin in place of the clothing tag 12.

The tag cover 14 can be similarly used for clothing tags in various locations of a garment. For example, some articles of clothing include a clothing tag along a side seam. Moreover, the tag cover 14 can also be used to cover clothing seams that may be uncomfortable for the wearer. The tag cover 14 can be easily removed when access to the clothing tag 12 or clothing seam is needed, for example, to read size or care information from the clothing tag 12 or to sell or give away the article of clothing 10.

The tag cover 14 can be provided in various shapes and sizes. The tag cover 14 can be wider and longer than the clothing tag 12 so as to cover the tag and allow the adhesive layer 18 to adhere to the article of clothing 10 about the perimeter of the clothing tag 12. Typically, the tag cover 14 can be from about ¾ inch to about 1.5 inches wide. In some embodiments, the tag cover 14 can be provided on a spool and disposed from a tag cover dispenser 20. The tag cover dispenser can allow the user to remove a desired length of tag cover 14. This design allows for shorter pieces of the tag cover 14 to cover clothing tags 12, and longer pieces of the tag cover 14 to cover seams with a single piece.

The soft fabric layer 16 can be made of a soft flexible fabric. In some embodiments, the soft fabric layer 16 may be made of a material that is the same as the material of the article of clothing 10. The clothing tag 14 could be made in various colors to help match the clothing tag 14 with the color of the article of clothing 10.

It should be understood, of course, that the foregoing relates to exemplary embodiments of the invention and that modifications may be made without departing from the spirit and scope of the invention as set forth in the following claims.

What is claimed is:

1. A method for covering a portion of an inside of an article of clothing, the method comprising:
placing a tag cover over the portion of the inside of the article of clothing, wherein the tag cover has a soft fabric layer and an adhesive layer disposed on one side of the soft fabric layer, wherein the soft fabric layer is disposed outward toward a wearer of the article of clothing.

2. The method of claim 1, wherein the portion of the inside of the article of clothing is a clothing tag.

3. The method of claim 1, wherein the portion of the inside of the article of clothing is a clothing seam.

4. The method of claim 2, further comprising covering the entirety of the clothing tag with the tag cover.

5. The method of claim 1, further comprising removing a desired length of tag cover from a tag cover dispenser.

6. A method for reducing discomfort from clothing tags or seams, comprising:
obtaining a desired length of a tag cover, the tag cover including a soft fabric layer with an adhesive layer disposed on one side of the soft fabric layer; and
disposing the tag cover over the clothing tags or seams, wherein the soft fabric layer is disposed outward toward the wearer.

7. The method of claim 6, further comprising covering the entirety of the clothing tag or seam with the tag cover.

8. The method of claim 6, further comprising removing a desired length of tag cover from a tag cover dispenser.

9. The method of claim 6, further comprising removing the tag cover to provide access to the clothing tag or seam previously covered by the tag cover.
